(19) United States
(12) Patent Application Publication
(10) Pub. No.: US 2012/0124316 A1
(43) Pub. Date: May 17, 2012

(54) LEAKAGE REDUCTION IN STORAGE ELEMENTS VIA OPTIMIZED RESET STATES

(76) Inventor: Aswin K. Gunasekar, Austin, TX (US)

(21) Appl. No.: 12/948,405

(22) Filed: Nov. 17, 2010

(51) Int. Cl. G06F 12/00

(52) U.S. Cl. 711/166; 711/E12.001

(57) ABSTRACT

Various methods are provided for leakage reduction via optimized reset states and improving performance for storage elements. The methods include selecting a storage element, where the storage element comprises at least one storage element component sized to reduce static current leakage or at least one storage element component adapted to increase at least one of speed or performance of the storage element. The methods also call for determining a preferred reset state for the storage element, wherein the preferred reset state is based at least upon the reduction of static current leakage, the speed or the performance of the storage element. The methods also call for setting the storage element reset state to the preferred reset state. An additional method calls for determining if a storage element spends a predetermined amount of time in a static state, and determining a preferred reset state for the storage element based upon at least the static state in which the storage element spends the at least a predetermined amount of time. The additional method also calls for setting a preferred reset state based at least upon the static state in which the storage element spends the at least a predetermined amount of time.

### BACKGROUND

1. Field of the Invention

Embodiments of this invention relate generally to semiconductor storage elements, and, more particularly, to a method and apparatus for leakage reduction via optimized reset states.

2. Description of Related Art

Computer circuitry has evolved from relatively simple, basic implementations to complex, high-speed designs. An increase in speed, features and capabilities of modern communications, computing and processing devices has driven computer circuitry to consume more power in many areas. Such power-intensive circuit designs have been a challenge for designers and a problem for consumers, for example, in mobile devices where battery life may be negatively affected by such power-intensive circuit designs. Similarly, products like desktop and laptop computers, computer monitors and the like have increased their feature sets, complexity and speed. Designers have attempted to ameliorate battery life and power consumption issues by developing devices that consume less power during normal operations as well as when not in use by users.

Typically, at a computer circuit level, modern communications, computing and processing devices are based upon standard building block devices such as latches, flip-flops, combinatorial logic, buffers and inverters, transistors and the like. Storage elements like latches and flip-flops hold existing data values and “clock in” new values. Loading new values into storage elements like latches and flip-flops requires that the latches and flip-flops be “switched,” a process by which, for example, a new data value is loaded into a latch or flip-flop corresponding with a clocking signal or the like. While “switching” the latches and flip-flops are actively working. However, there are times during which storages elements, such as latches and flip-flops, are not switching. That is, storage elements also spend time in “static states” where no changes to stored data values take place. During such “static states,” storage elements, such as latches and flip-flops, along with their respective sub-components, are susceptible to static power dissipation, or power leakage. Leakage current refers to the amount of current dissipated by one or more components of a storage element while in a “static state” (i.e., while the storage element is not “switching”). When a storage element is not switching, its inactive components continue to dissipate power; any static power dissipation is especially costly because the dissipated power is essentially wasted. Such static leakage may be seen as the cost of keeping the storage element powered on at a specified voltage and current. Thus, there is a need for designs with improved leakage efficiency to reduce this cost. Current circuit implementations using standard storage elements attempt to reduce this problem by designing for overall operation considerations, such as “stacking” transistors to reduce leakage, but such designs still suffer from leakage optimization issues.

Similarly, storage elements have characteristics related to speed for switching time, clock-to-output time, hold time, setup time and the like which may effect timing for the electrical circuit path in which the storage element resides. Current circuit design implementations using standard storage elements attempt to reduce timing by selecting standard storage elements with desired clock-to-output, hold or setup characteristics in order to improve some aspect of circuit path timing, but such designs still suffer from timing optimization issues.

### SUMMARY OF EMBODIMENTS OF THE INVENTION

In one embodiment of the present invention, a method is provided. The method includes selecting a storage element, the storage element comprising at least one storage element component sized to reduce static current leakage and determining a preferred reset state for the storage element, wherein the preferred reset state is based at least upon the reduction of static current leakage. The method also includes setting the storage element reset state to the preferred reset state.

In another embodiment of the present invention, a method is provided. The method includes selecting a storage element, where the storage element comprising at least one storage element component adapted to increase at least one of speed or performance of the storage element. The method also includes determining a preferred reset state for the storage element, wherein the preferred reset state is based at least upon the increase of at least one of speed or performance of the storage element and setting the storage element reset state to the preferred reset state.

In yet another embodiment of the present invention, a method is provided. The method includes determining a preferred reset state for a storage element, where the preferred reset state is based upon at least one of a reduction in leakage current, an increase in the storage element speed or an increase in the storage element performance. The method also calls for setting the storage element reset state to the preferred reset state.

In yet another embodiment of the present invention, a method is provided. The method calls for determining if a storage element spends a predetermined amount of time in a static state, and determining a preferred reset state for the storage element based upon at least the static state in which the storage element spends the at least a predetermined amount of time. The method also calls for setting a preferred reset state based at least upon the static state in which the storage element spends the at least a predetermined amount of time.

### BRIEF DESCRIPTION OF THE DRAWINGS

The invention may be understood by reference to the following description taken in conjunction with the accompanying drawings, in which the leftmost significant digit(s) in the reference numerals denote(s) the first figure in which the respective reference numerals appear, and in which:

FIG. 1 schematically illustrates a simplified block diagram of a computer system including a graphics card that employs a storage scheme according to one exemplary embodiment;

FIG. 2 shows a simplified block diagram of a multiple computer system connected via a network according to one exemplary embodiment;

FIGS. 3A-3B illustrate a simplified, exemplary representation of a storage element, and an array of storage elements, which may be used in silicon chips, as well as devices depicted in FIGS. 1 and 2, according to one exemplary embodiment;

FIG. 3C illustrates a simplified, exemplary representation of a semiconductor fabrication facility used to produce a semiconductor wafer or product, according to one exemplary embodiment;

FIG. 4 illustrates detailed representation of a standard prior art storage element with symmetric sizing;

FIG. 5 illustrates a detailed representation of a storage element with optimizations for leakage, speed and/or performance, according to one exemplary embodiment;

FIG. 6 illustrates a detailed representation of a pair of cross-coupled inverters in the optimized storage element of FIG. 5, according to one exemplary embodiment;

FIG. 7 illustrates an operational flowchart for reducing leakage or increasing speed/performance in a storage element, according to one exemplary embodiment; and

FIG. 8 illustrates an operational flowchart for determining a preferred reset state in a storage element, according to one exemplary embodiment.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed, but, on the contrary, the intention is to cover all modifications, equivalents, and alternatives falling within the spirit and scope of the invention as defined by the appended claims.

### DETAILED DESCRIPTION

Illustrative embodiments of the invention are described below. In the interest of clarity, not all features of an actual implementation are described in this specification. It will of course be appreciated that in the development of any such actual embodiment, numerous implementation-specific decisions may be made to achieve the developers' specific goals, such as compliance with system-related and business-related constraints, which may vary from one implementation to another. Moreover, it will be appreciated that such a development effort might be complex and time-consuming, but may nevertheless be a routine undertaking for those of ordinary skill in the art having the benefit of this disclosure.

Embodiments of the present invention will now be described with reference to the attached figures. Various structures, connections, systems and devices are schematically depicted in the drawings for purposes of explanation only and so as to not obscure the disclosed subject matter with details that are well known to those skilled in the art. Nevertheless, the attached drawings are included to describe and explain illustrative examples of the present invention. The words and phrases used herein should be understood and interpreted to have a meaning consistent with the understanding of those words and phrases by those skilled in the relevant art. No special definition of a term or phrase, i.e., a definition that is different from the ordinary and customary meaning as understood by those skilled in the art, is intended to be implied by consistent usage of the term or phrase herein. To the extent that a term or phrase is intended to have a special meaning, i.e., a meaning other than that understood by skilled artisans, such a special definition will be expressly set forth in the specification in a definitional manner that directly and unequivocally provides the special definition for the term or phrase.

The use of any size complementary metal-oxide semiconductor (CMOS) implementation and technology is contemplated for carrying out various embodiments described herein. Additionally, non-CMOS implementations are also contemplated.

The term “storage element,” as used herein, means a flip-flop, a latch, a register, a bitcell or the like, as would be understood by one of ordinary skill in the art having the benefit of this disclosure. Storage elements may be comprised of one or more storage element components such as metal oxide semiconductor field effect transistors (MOSFETs), other transistors, or the like; storage element components may also be combinations of two or more MOSFETs, other transistors, or the like. “Storage elements” may also encompass groups or arrays of the above mentioned examples. The term “electronic device” may include storage elements specifically in addition to desktop and laptop computers, servers and computing devices, electronic components (e.g., storage drives/hard drives, memory, field programmable gate arrays (FPGAs), application specific integrated circuits (ASICs), programmable logic arrays and programmable array logics (PLAs/PALs), complex programmable logic devices (CPLDs), microprocessors, microcontrollers, floppy drives, tape drives, compact disc and digital video disc (CD-ROM and DVD) drives, and the like, computer monitor devices, printers and scanners, processing devices, wireless devices, personal digital assistants (PDAs), mobile phones, portable music players, video games and video game consoles, external memory devices (e.g., Universal Serial Bus (USB) thumb drives, external hard drives, and the like), audio and video players, stereos, televisions, manufacturing equipment, automobiles and motorcycles, electrical systems in mass-transit vehicles (e.g., buses, trains, airplanes, and the like), security systems and any other device or system employing storage elements. Additionally, an “electronic device” may be an apparatus employing elements of a “storage element,” as discussed above. An “electronic device” may include one or more “storage elements,” one or more arrays of “storage elements,” and/or one or more silicon chips.

The term “standard storage element” refers to storage elements, as commonly used in the industry, not having the added benefits and features described in the various embodiments of the present invention. For example, as noted in the Background above, current implementations of circuit designs may use “standard” flip-flops and latches. As shown under one or more embodiments herein, an optimization and/or reduction of leakage (i.e., and leakage current and power dissipation) via use of optimized reset states, allows improvement(s) over “standard storage elements.” Under one or more embodiments presented herein, leakage reduction may be implemented in a storage element (e.g., a flip-flop, latch or the like) utilizing storage element components (e.g., MOSFETs or the like) sized differently from “standard storage element” transistor components (e.g., “standard” flip-flop transistors). Under various embodiments herein, one or more storage element components may be sized to reduce leakage (e.g., sized smaller to use less current in a static state).

It is contemplated that different embodiments described herein may be implemented together in various combinations, as would be apparent to one of skill in the art having the benefit of this disclosure. That is, embodiments depicted herein are not mutually exclusive of each other and may be practiced alone, or in any combination, in accordance with the descriptions herein.

Embodiments of the present invention generally provide for leakage reduction by using optimized reset states for storage elements in different computing and processing devices.

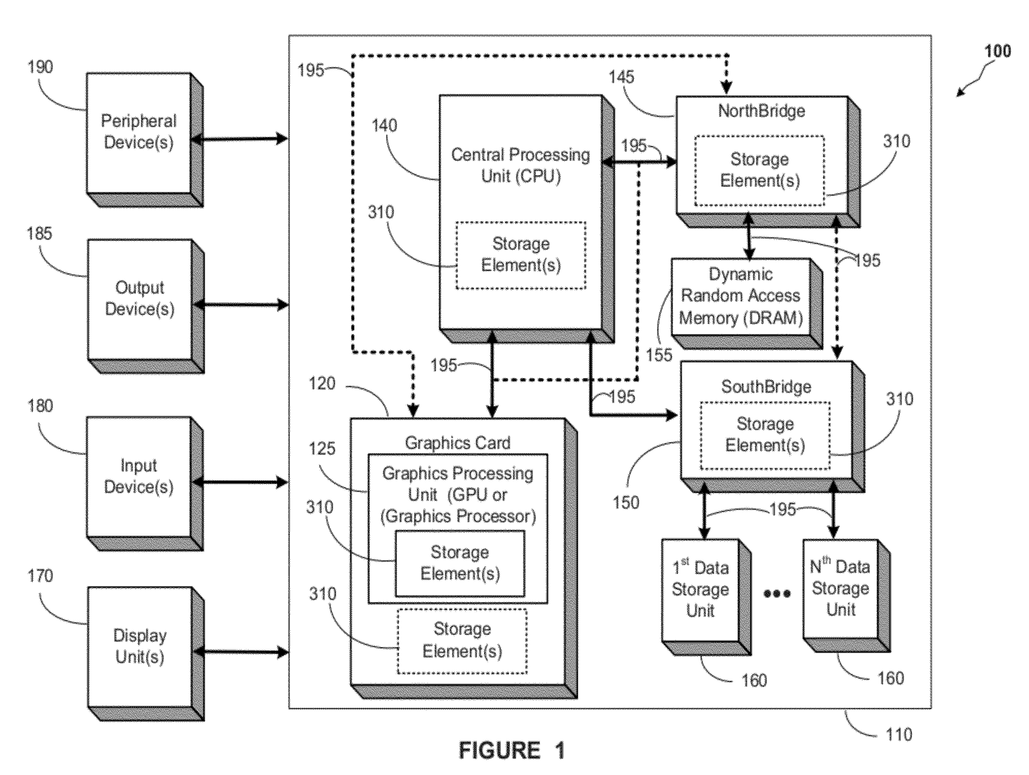

Turning now to FIG. 1, a block diagram of an exemplary computer system 100, in accordance with an embodiment of the present invention, is illustrated. In various embodiments, the computer system 100 may be a personal computer, a laptop computer, a handheld computer, a mobile device, a telephone, a personal data assistant (PDA), a server, a mainframe, a work terminal, or the like. The computer system 100 includes a main structure 110 which may be a computer motherboard, circuit board or printed circuit board, a desktop computer enclosure and/or tower, a laptop computer base, a server enclosure, part of a mobile device, personal data assistant (PDA), or the like. In one embodiment, the main structure 110 includes a graphics card 120. In one embodiment, the graphics card 120 may be an ATI Radeon™ graphics card from Advanced Micro Devices (“AMD”) or any other graphics card using memory, in alternate embodiments. The graphics card 120 may, in different embodiments, be connected on a Peripheral Component Interconnect (PCI) Bus (not shown), PCI-Express Bus (not shown) an Accelerated Graphics Port (AGP) Bus (also not shown), or any other connection known in the art. It should be noted that embodiments of the present invention are not limited by the connectivity of the graphics card 120 to the main computer structure 110. In one embodiment, the computer system 100 runs an operating system such as Linux, UNIX, Windows, Mac OS, or the like.

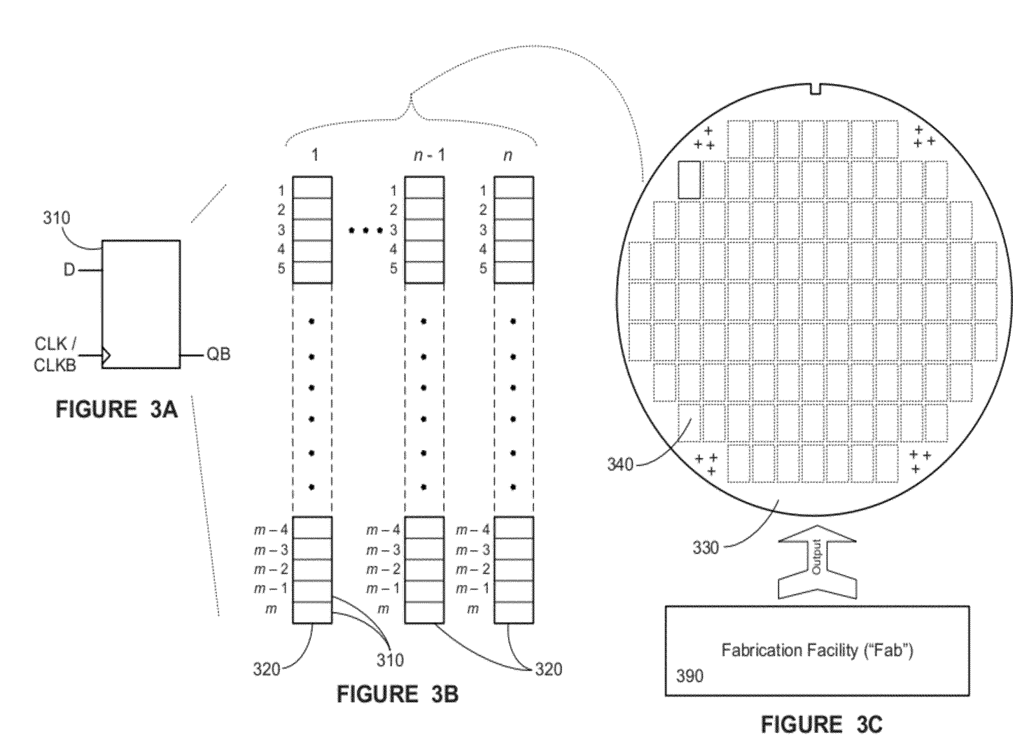

In one embodiment, the graphics card 120 may contain a graphics processing unit (GPU) 125 used in processing graphics data. The GPU 125, in one embodiment, may include a storage element 310 (discussed in further detail below with respect to FIG. 3). In one embodiment, the storage element 310 may be an array of storage elements 320 (FIG. 3) which may be part of an embedded random access memory (RAM), an embedded static random access memory (SRAM), or an embedded dynamic random access memory (DRAM), a CPU 140, GPU 120 or some other integrated circuit (IC). In alternate embodiments, the storage element 310 or array of elements 320 may be embedded in the graphics card 120 in addition to, or instead of, being embedded in the GPU 125. In various embodiments the graphics card 120 may be referred to as a circuit board or a printed circuit board or a daughter card or the like.

In one embodiment, the computer system 100 includes a central processing unit (CPU) 140, which is connected to a northbridge 145. The CPU 140 and northbridge 145 may be housed on the motherboard (not shown) or some other structure of the computer system 100. It is contemplated that in certain embodiments, the graphics card 120 may be coupled to the CPU 140 via the northbridge 145 or some other connection as is known in the art. For example, the CPU 140, the northbridge 145, and the GPU 125 may be included in a single package or as part of a single die or “chips.” Alternative embodiments, which alter the arrangement of various components illustrated as forming part of main structure 110, are also contemplated. The CPU 140 and/or the northbridge 145, in certain embodiments, may each include storage elements 310 and/or arrays of storage elements 310 in addition to other storage elements 310 found elsewhere in the computer system 100. In certain embodiments, the northbridge 145 may be coupled to a system RAM (or DRAM) 155; in other embodiments, the system RAM 155 may be coupled directly to the CPU 140. The system RAM 155 may be of any type of RAM known in the art. The type of RAM 155 does not limit the embodiments of the present invention. In one embodiment, the northbridge 145 may be connected to a southbridge 150. In other embodiments, the northbridge 145 and southbridge 150 may be on the same chip in the computer system 100, or the northbridge 145 and southbridge 150 may be on different chips. In one embodiment, the southbridge 150 may have a storage element 310, in addition to any other a storage elements 310 elsewhere in the computer system 100. In various embodiments, the southbridge 150 may be connected to one or more data storage units 160. The data storage units 160 may be hard drives, solid state drives, magnetic tape, or any other writable media used for storing data. In various embodiments, the central processing unit 140, northbridge 145, southbridge 150, graphics processing unit 125 and/or DRAM 155 may be a computer chip or a silicon-based computer chip, or may be part of a computer chip or a silicon-based computer chip. In one or more embodiments, the various components of the computer system 100 may be operatively, electrically and/or physically connected or linked with a bus 195 or more than one bus 195.

In different embodiments, the computer system 100 may be connected to one or more display units 170, input devices 180, output devices 185 and/or other peripheral devices 190. It is contemplated that in various embodiments, these elements may be internal or external to the computer system 100, and may be wired or wirelessly connected, without affecting the scope of the embodiments of the present invention. The display units 170 may be internal or external monitors, television screens, handheld device displays, and the like. The input devices 180 may be any one of a keyboard, mouse, track-ball, stylus, mouse pad, mouse button, joystick, scanner or the like. The output devices 185 may be any one of a monitor, printer, plotter, copier or other output device. The peripheral devices 190 may be any other device which can be coupled to a computer: a CD/DVD drive capable of reading and/or writing to physical digital media, a USB device, Zip Drive, external floppy drive, external hard drive, phone and/or broadband modem, router/gateway, access point and/or the like. To the extent certain exemplary aspects of the computer system 100 are not described herein, such exemplary aspects may or may not be included in various embodiments without limiting the spirit and scope of the embodiments of the present invention as would be understood by one of skill in the art.

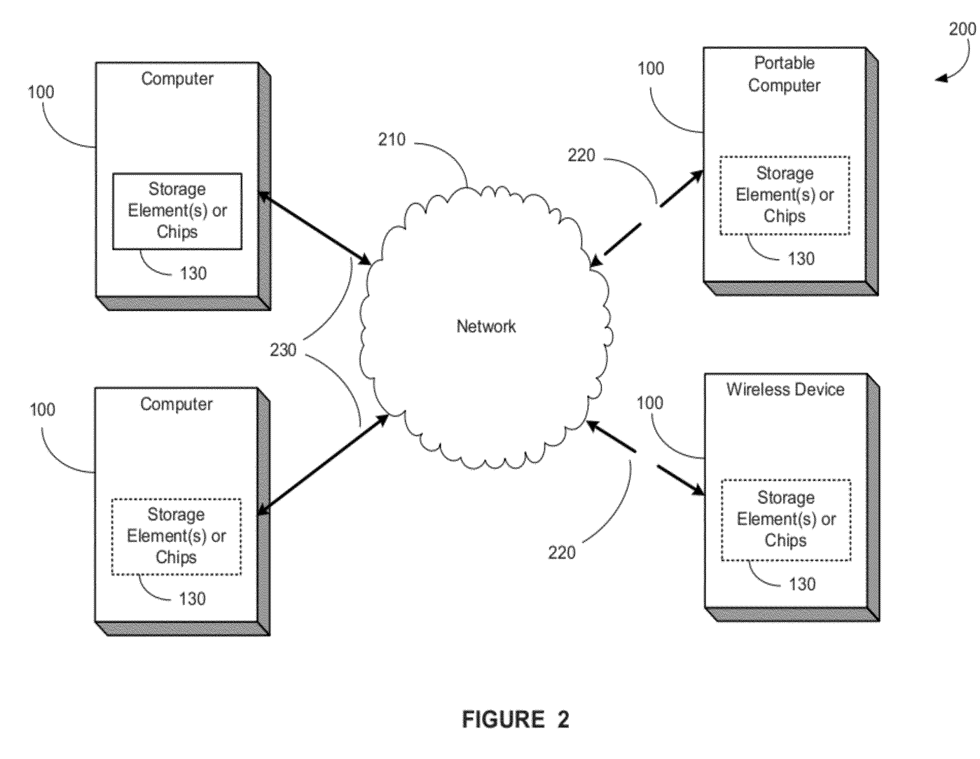

Turning now to FIG. 2, a block diagram of an exemplary computer network 200, in accordance with an embodiment of the present invention, is illustrated. In one embodiment, any number of computer systems 100 may be communicatively coupled and/or connected to each other through a network infrastructure 210. In various embodiments, such connections may be wired 230 or wireless 220 without limiting the scope of the embodiments described herein. The network 200 may be a local area network (LAN), wide area network (WAN), personal network, company intranet or company network, the Internet, or the like. In one embodiment, the computer systems 100 connected to the network 200 via network infrastructure 210 may be a personal computer, a laptop computer, a handheld computer, a mobile device, a telephone, a personal data assistant (PDA), a server, a mainframe, a work terminal, or the like. The number of computers depicted in FIG. 2 is exemplary in nature; in practice any number of computer systems 100 maybe coupled/connected using the network 200.

Turning now to FIGS. 3A-3C, a simplified, exemplary representation of a storage element 310, and an array 320 of the storage elements 310, which may be used in silicon chips 340, as well as devices depicted in FIGS. 1 and 2, according to one embodiment is illustrated. FIG. 3A depicts an exemplary storage element 310 (here a QB, non-scan, D flip-flop), in accordance with one embodiment; however, those skilled in the art will appreciate that the storage element 310 may take on any of a variety of forms, including those previously described above, without departing from the spirit and scope of the instant invention. The storage elements 310 may be implemented as single elements (310) or in arrays 320 or in other groups (not shown).

Turning to FIG. 3B, the array 320 is illustrated as being formed from a plurality of the storage elements 310, and may be arranged in n columns where each column consists of m rows. In other words, the array 320 may be comprised of an arrangement of “m×n” storage elements 310. It is contemplated that both m and n may be an integer greater than or equal to 1. For example, according to two specific embodiments, the array 320 may consist of a single storage element 310 (a 1×1 array, where m=1 and n=1) or may consist of 65,536 storage elements 310 (a 256×256 array, where m=256 and n=256) or consist of 256 storage elements 310 (a 256×1 array, where m=256 and n=1), or any other configuration as would be apparent to one of skill in the art having the benefit of this disclosure. As discussed above, the arrays 320 of storage elements 310 may be used in a wide variety of electronic devices, including, but not limited to, central and graphics processors, motherboards, graphics cards, combinatorial logic implementations, register banks, memory, other integrated circuits (ICs), or the like.

Turning now to FIG. 3C, in accordance with one embodiment, one or more of the arrays 320 of the storage elements 310 may be included on the silicon chip 340 (or computer chip). The silicon chip 340 may contain one or more different configurations of the arrays 320 of the storage elements 310. The silicon chips 340 may be produced on a silicon wafer 330 in a fabrication facility (or “fab”) 390. That is, the silicon wafers 330 and the silicon chips 340 may be referred to as the output, or product of, the fab 390. The silicon chips 340 may be used in electronic devices, such as those described above in this disclosure.

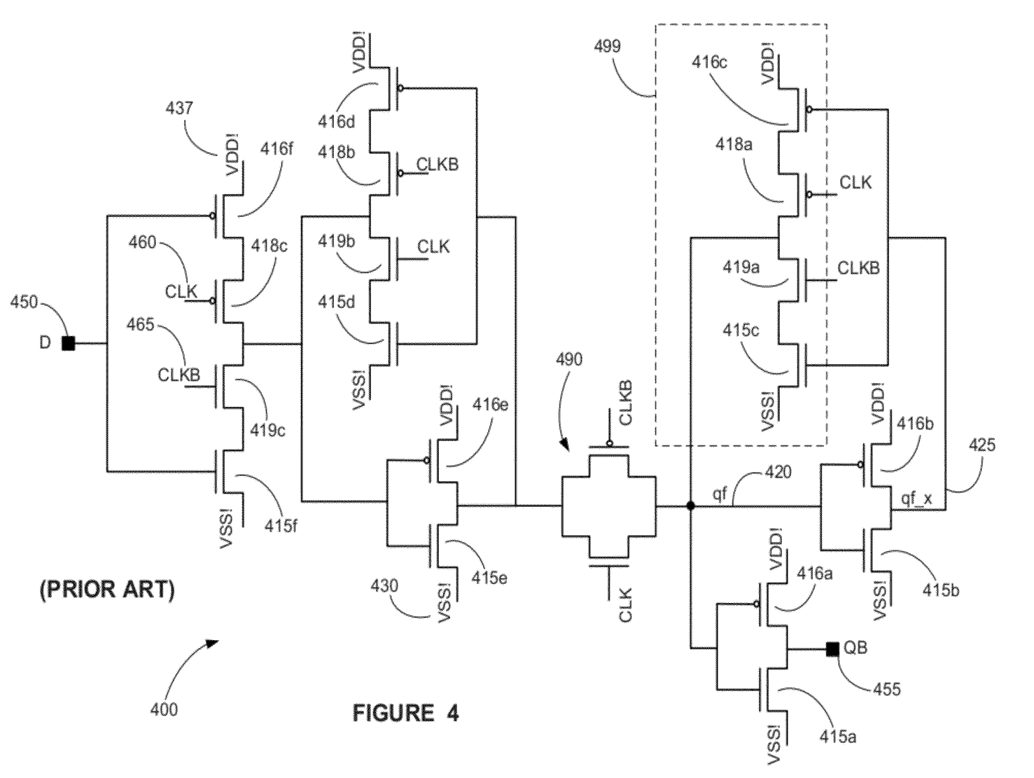

Turning now to FIG. 4, a detailed representation of a standard prior art storage element 400 is depicted. The storage element 400 depicted is exemplified as a standard, inverted output flip-flop. The prior art storage element 400 is depicted as a configuration of metal oxide semiconductor field effect transistors (MOSFETs). The MOSFETs depicted are shown as n-type (nFET) and p-type (pFET) MOSFETs, as would be apparent to one of skill in the art having the benefit of this disclosure. The prior art storage element 400 includes a power node (VDD!) 437 (as called a “non-ground potential node” herein) and a ground node (VSS!) 435. The power node VDD! 437 is connected to various components of the prior art storage element 400 via pFETs 416a-f, and the ground node VSS! 430 is connected to various components of the prior art storage element 400 via nFETs 415a-f. The prior art storage element 400 includes an input terminal 450 (“D”) and an inverted output terminal 455 (“QB”). The value provided at input 450 is clocked in using clocking signals CLK 460 and CLKB 465 as well as a clocking component 490. Clocking signals CLK 460 and CLKB 465 are presented to clocking gates of the pFETs and nFETs as shown in FIG. 4. Once clocked in, the input value is stored at a storage node 420 (“qf”). A corresponding inverted input value is stored in a storage node 425 (“qf_x”). An inverted storage value, corresponding to the value stored at storage node 420, is presented at the inverted output terminal 455.

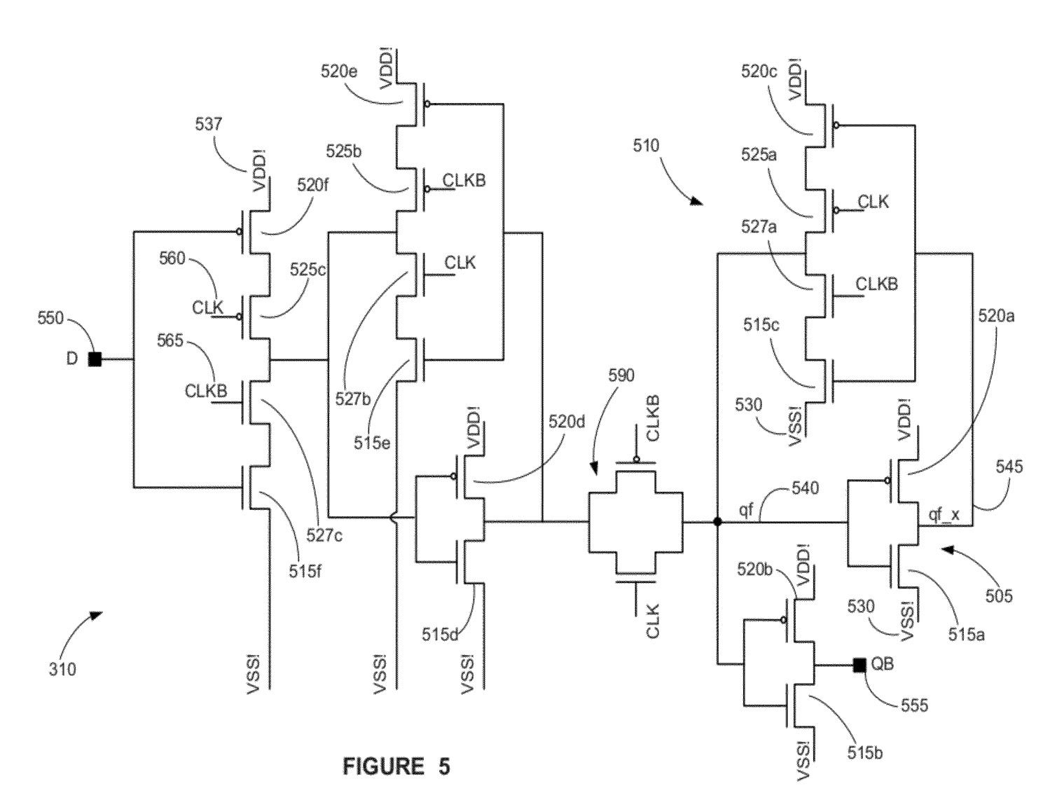

Still referring to FIG. 4, the implementations of standard prior art storage elements (400) use transistor stacking in an attempt to alleviate leakage concerns. A group of MOSFETs stacked in standard prior art storage element 400 are shown as a stacked group 499. The stacked group 499 consists of pFETs 416c and 418a as well as nFETs 415c and 419a. The end-to-end configuration of the pFETs 416c, 418a and the nFETs 415c, 419a of the stacked group 499 allows for some reduction in leakage based upon the inherent properties of MOSFETs in this type of configuration. The stacked group 499 may be one of a pair of stacked groups 499 which are part of a cross-coupled inverter component (discussed in further below in FIG. 5). Standard prior art storage element 400 configurations symmetrically size stack groups 499 used to make cross-coupled inverter components. For example, the MOSFETs of the stack group 499, as shown in FIG. 4, will be sized the same as the MOSFETs in the clocking component 490 and the nFET 415b, pFET 416b pair. In this configuration, the MOSFETs in the standard prior art storage element 400 will operate the same regardless of whether a particular MOSFET receives power for a majority of the time the standard prior art storage element 400 receives power. In other words, because blanket optimizations are made to these components with respect to sizing and skewing, this symmetric stacking scheme has inherent inefficiencies.

Turning now to FIG. 5, a detailed and exemplary embodiment of the storage element 310, in accordance with one or more embodiments, is depicted. As depicted in FIG. 5, the storage element 310 may be, in some embodiments, a flip-flop. The storage element 310 is depicted as a configuration of n-type (nFET) and p-type (pFET) MOSFETs, as would be apparent to one of skill in the art having the benefit of this disclosure. The storage element 310 includes a power node (VDD!) 537 (also called a “non-ground potential node” herein) and a ground node (VSS!) 530. The power node VDD! 537 is connected to various components of the storage element 310 via pFETs 520a-520f, and the ground node VSS! 530 is connected to various components of the storage element 310 via nFETs 515a-515f. The storage element 310 includes an input terminal 550 (“D”) and an inverted output terminal 555 (“QB”). Clocking signals CLK 560 and CLKB 565 as well as a clocking component 590 are used to controllably pass any value presented at the input terminal 550. The clocking signal CLK 560 is presented to clocking gates of pFETs 525a, 525c and nFET 527b, and the clocking signal CLKB 565 is presented to clocking gates of pFET 525b and nFETs 527a, 527c. Once clocked in, the input value presented at the input terminal 550 is stored at a storage node 540 (“qf”). A corresponding inverted input value is stored in a node 545 (“qf_x”). An inverted storage value, corresponding to the value stored at the storage node 540, is presented at the inverted output terminal 555.

Referring now to FIG. 5, in one or more embodiments, the storage element 310 includes a pair of cross-coupled inverters 505 and 510. In an exemplary embodiment, as shown in FIG. 5, the inverter 505 includes the nFET 515a connected to the ground node VSS! 530 and to the pFET 520a, the pFET 520a also being connected to the power node VDD! 537. The inverter 505 configuration also includes the clocking component 590. In one embodiment, the gates of the inverter 505 are connected to the storage node 540, and the storage node 545 is connected to the drain of the nFET 515a and the drain of the pFET 520a, as shown in FIG. 5. In an exemplary embodiment, the inverter 510 includes the nFET 515c connected to the ground node VSS! 530 and to the nFET 527a that has its gate coupled to the CLKB 565. The nFET 527a may be connected to the pFET 525a that has its gate coupled to the CLK 560. The pFET 525a may in turn be connected to the pFET 520c (the pFET 520c also being connected to the power node VDD! 537). In one embodiment, the gates of the nFET 515c and the pFET 520c of inverter 510 are connected to the storage node 545, and the storage node 540 is connected to the drain of the nFET 527a and the drain of the pFET 525a, as shown in FIG. 5. Such a configuration may allow the pair of cross-coupled inverters 600 to drive each other.

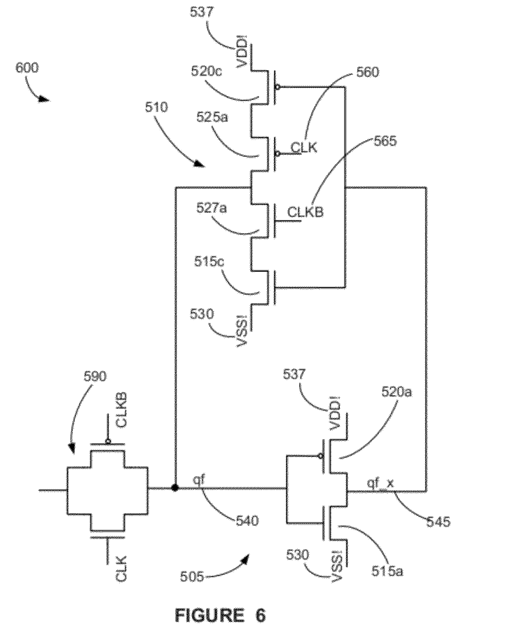

Turning now to FIG. 6, a detailed representation 600 of the pair of cross-coupled inverters 505 and 510 in the storage element 310 of FIG. 5, according to one exemplary embodiment, is depicted. As previously discussed, symmetric sizing and skewing of the storage elements 310 (e.g., flip-flops, latches, bitcells or the like) leads to leakage inefficiencies. For example, symmetrically sizing the nFETs and pFETs of the cross-coupled inverters 505 and 510 leads to inefficiencies with respect to leakage. Generally, devices such as the storage element 310 will have a preferred reset state value. In some cases it will be desirable to have the storage element 310 come out of a reset state with a value of ‘1’ on its output terminal 555. In other cases, it may be desirable to have the storage element 310 come out of reset with a ‘0’ value on its output terminal 555. Such preferences may be relevant to overall circuit design, but the actual preference of a reset state value (i.e., ‘1’ or ‘0’) is not essential to the various embodiments presented herein. Various embodiments herein may allow for the sizing and/or skewing of various components of the storage element 310 in order to reduce leakage. In accordance with one or more embodiments, the MOSFET components of a storage element 310 may be sized and/or skewed to reduce leakage. For example, a MOSFET with a smaller size and/or leakage component may be selected as the desired nFET or pFET component in a circuit. As another example, a MOSFET skewed for faster transition to or from a particular state may save time and increase speed of the storage element 310. Additionally, a combination of size and skew optimizations may serve to improve the overall performance of the storage element 310.

In accordance with one or more embodiments, the nFETs and pFETs of the storage element 310 may be asymmetrically sized and/or skewed to improve performance and/or increase the speed (e.g., operating speed) of the storage element 310. For example, the storage element 310 may include nFET and pFET configurations and/or sizes that allow the storage element 310 to more quickly transition from being in reset to the preferred reset state (after coming out of reset). Similarly, in some embodiments, the storage element 310 may be configured to quickly transition from a static state (e.g., the preferred reset state) to an alternate state. If the storage element remains in a static state of ‘1’ or ‘0’ for some length of time, the first transition of the storage element 310 will be from the static state, to another state. In other words, by skewing the storage element 310 to take advantage of an extended static state duration, i.e., the preferred reset state, the overall switching speed of the storage element 310 may be increased.

In accordance with one or more embodiments, the nFETs and pFETs of the storage element 310 may be asymmetrically sized and/or skewed to reduce leakage. With respect to FIG. 6, various nFETs and/or pFETs of the cross-coupled inverter pair 600 may be asymmetrically sized and/or skewed to reduce leakage. In accordance with one embodiment, the nFET 515c of the cross-coupled inverter 510 may be sized in a manner appropriate to reduce leakage. In one embodiment, it may be determined that the desired reset state value of a storage element 310 is ‘1’. That is, when the storage element 310 comes out of reset, its output terminal 555 will present an output value of ‘1’. If the storage element 310 is not switched for an extended period of time, the value of ‘1’ is maintained in the storage element 310. Under such a configuration, the nFET 515c remains “on” while the pFET 520c remains “off”; that is, when the storage element 310 remains in a static or unchanging state (e.g., holding a value of ‘1’ for an extended period of time), the nFET 515c remains “on” while the pFET 520c remains “off.” This configuration allows a value of ‘0’ to be output for storage node (540) by the cross-coupled inverter 510, therefore the inverted output terminal 555 will output a value of ‘1’.

In accordance with one embodiment, the pFET 520c of the cross-coupled inverter 510 may be sized in a manner appropriate to reduce leakage. That is, the pFET 520c may be reduced in size, changed in channel/gate configuration or the like. In one embodiment, it may be determined that the desired reset state value of a storage element 310 is ‘0’. That is, when the storage element 310 comes out of reset, its output terminal 555 will present an output value of ‘0’. If the storage element 310 is not switched for an extended period of time, the value of ‘0’ is maintained in the storage element 310. Under such a configuration, the pFET 520c remains “on” while the nFET 515c remains “off”; that is, when the storage element 310 remains in a static or unchanging state (e.g., holding a value of ‘0’ for an extended period of time), the pFET 520c remains “on” while the nFET 515c remains “off.” The longer the preferred reset state is maintained, the longer power dissipates (i.e., the greater the overall leakage) from the nFET or pFET component which remains “off” in order to maintain the preferred reset state.

Referring still to FIG. 6, it should be noted that sizing and/or skewing considerations for leakage reduction, as described above with respect to FIG. 6, may be implemented in other nFETs and pFETs in the storage element 310 that remain in a static, non-switching state for any determined period of time. For example, in one embodiment, the nFET 515a may remain “off,” thus holding the cross-coupled inverter 505 output (i.e., storage node 545) to a value of ‘1’. As such, the nFET 515a may be sized to reduce leakage. Similarly, in one embodiment, the pFET 520a may instead remain “off,” thus holding the cross-coupled inverter 510 output (i.e., storage node 545) to a value of ‘0’. As such, the pFET 520a may be sized to reduce leakage.

It is to be noted that sizing and/or skewing as described herein is not limited to a single MOSFET in the storage element 310. In other words, multiple MOSFETs in a storage element 310 may be sized and/or skewed appropriately, and it is contemplated that multiple MOSFETs may be sized and/or skewed in such a way that complements other MOSFETs in the circuit. Referring to the preceding exemplary descriptions with respect to FIG. 6, it may be desired that the reset state value of the storage element 310 is ‘1’. In this configuration, as described above, the cross-coupled inverter 505 will maintain an output value of ‘1’ on the storage node 540, while the cross-coupled inverter 510 will maintain an output value of ‘0’ on storage node 545. Thus, in accordance with one embodiment, when maintaining a static output value of ‘1’ in the storage element 310, the cross-coupled inverter 505 will maintain an output value of ‘1’ on the storage node 540, while the cross-coupled inverter 510 will maintain an output value of ‘0’ on the storage node 545. Put another way, the pFET 520a of the cross-coupled inverter 505 will remain “on,” and the nFET 515c and the nFET 527a of the cross-coupled inverter 510 will remain “on” when the storage element 310 holds a static value of ‘1’ at its inverted output terminal 555. The nFET 515a, the pFET 520c and the pFET 525a will thus remain “off.” The MOSFETs that remain “off” may be sized to reduce leakage. As evidenced herein, due to the nature of the cross-coupled inverter pair 600, the cross-coupled inverters 505 and 510 drive each other complementarily during operation. This means that when the desired reset value of the storage element 310 is ‘1’, the cross-coupled inverter 505 drives a ‘1’ on the storage node 545, and the cross-coupled inverter 510 drives a ‘0’ on the storage node 540. Thus, if the storage element 310 maintains a static value of ‘1’, the nFET 515a, the pFET 525a and/or the pFET 520c with remain “off” as long as the static state of the storage element 310 is maintained. Thus, in accordance with one embodiment, the nFET 515a, the nFET 525a and/or the pFET 520c may all be sized to reduce leakage. That is, sizing any of the nFET 515a, the nFET 525a and/or the pFET 520c may reduce leakage for a reset state of ‘1’. In other cases, leakage reduction can be achieved via further stacking, changing device type (e.g., from nFET to pFET or vise versa, or changing from a certain configuration of an nFET/pFET to another configuration of nFET/pFET), having longer channel length, or the like.

In an alternative embodiment, it may be desired that the reset state value of the storage element 310 is ‘0’. In this configuration, as described above, the cross-coupled inverter 505 will maintain an output value of ‘0’ on the storage node 540, while the cross-coupled inverter 510 will maintain an output value of ‘1’ on the storage node 545. Thus, in accordance with one embodiment, when maintaining a static output value of ‘0’ in the storage element 310, the cross-coupled inverter 505 will maintain an output value of ‘0’ on the storage node 540, while the cross-coupled inverter 510 will maintain an output value of ‘1’ on the storage node 545. Put another way, the nFET 515a of the cross-coupled inverter 505 will remain “on,” and the pFETs 520c and 525a of the cross-coupled inverter 510 will remain “on” when the storage element 310 holds a static value of ‘0’ at its inverted output terminal 555. As evidenced herein, due to the nature of the cross-coupled inverter pair 600, the cross-coupled inverters 505 and 510 drive each other complementarily during operation. This means that when the desired reset value of the storage element 310 is ‘0’, the cross-coupled inverter 505 drives a ‘0’ at the storage node 545, and the cross-coupled inverter 510 drives a ‘1’ at the storage node 540. As such, if the storage element 310 maintains a static value of ‘0’, the pFET 520c, the pFET 525a and the nFET 515a will remain “on” as long as the static state of the storage element 310 is maintained while the pFET 520a and the nFETs 515c and 527a remain “off.” Thus, in accordance with one embodiment, pFET 520a and the nFETs 515c and 527a (all together or in any combination) may be sized to reduce leakage.

It is also contemplated, in various embodiments, that other MOSFETs, singly, in pairs and/or in multiple MOSFET groups, may be sized and/or skewed in a manner similar to that described immediately above.

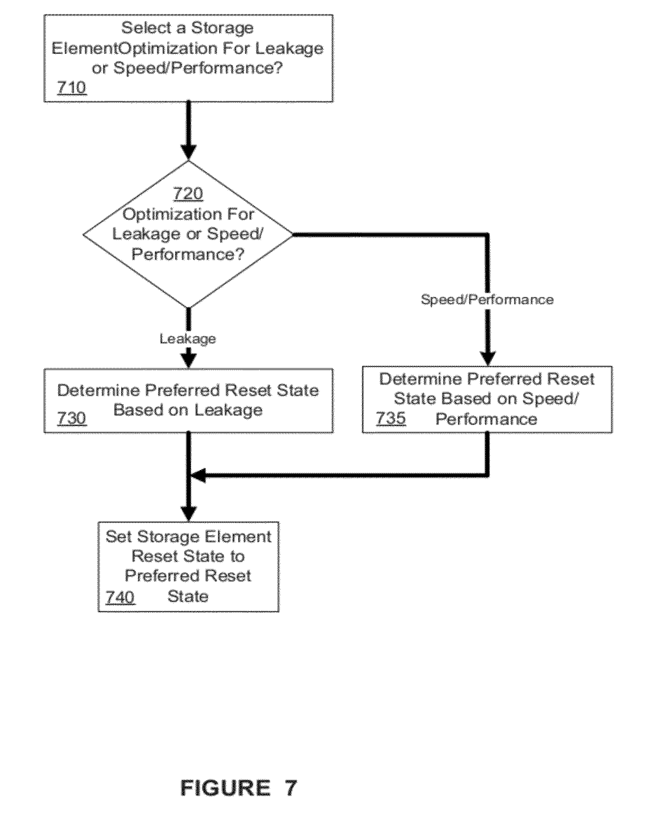

Turning now to FIG. 7, an operational flowchart for reducing leakage or increasing speed/performance in a storage element according to one embodiment of the present invention, is depicted. At step 710, a storage element 310 may be selected by a user, designer, automated system or the like. Typically, in accordance with one or more embodiments herein, the storage element 310 includes at least one storage element component sized, skewed and/or otherwise configured to reduce static current leakage and/or adapted to increase at least one of speed or performance of the storage element 310. In one or more embodiments, the storage element components may be MOSFETs, other transistors, inverters, cross-coupled inverters, combinations thereof, or the like. Once the storage element 310 is selected, the flow proceeds to step 720. At step 720, if it is determined that the storage element 310 is optimized for leakage reduction, then control proceeds to step 730. Alternatively, if it is determined that the storage element 310 is optimized for increased speed/performance, then control proceeds to step 735.

If the storage element is optimized for leakage reduction, a preferred reset state for the storage element 310 is determined at step 730. If the storage element is optimized for increased speed/performance, a preferred reset state for the storage element 310 is determined at step 735. The preferred reset state may be based, in whole or in part, upon the reduction of static current leakage and/or upon the increased speed/performance of the storage element 310. The preferred reset state of the storage element 310 may be set at step 740.

In one embodiment, a storage element may be selected based at least upon the storage element including one or more MOSFETs or other storage element components that are sized to reduce static current leakage. A preferred reset state for the storage element may be determined based at least upon the reduction of static current leakage. The storage element reset state may then be set to the preferred reset state.

In another embodiment, a storage element may be selected based at least upon the storage element including one or more MOSFETs or other storage element components with characteristic(s) for increasing the speed and/or performance of the storage element. A preferred reset state for the storage element may be determined based at least upon the characteristic(s). Such characteristics may include channel length, drive strength, size, type and/or skew. The storage element reset state may then be set to the preferred reset state.

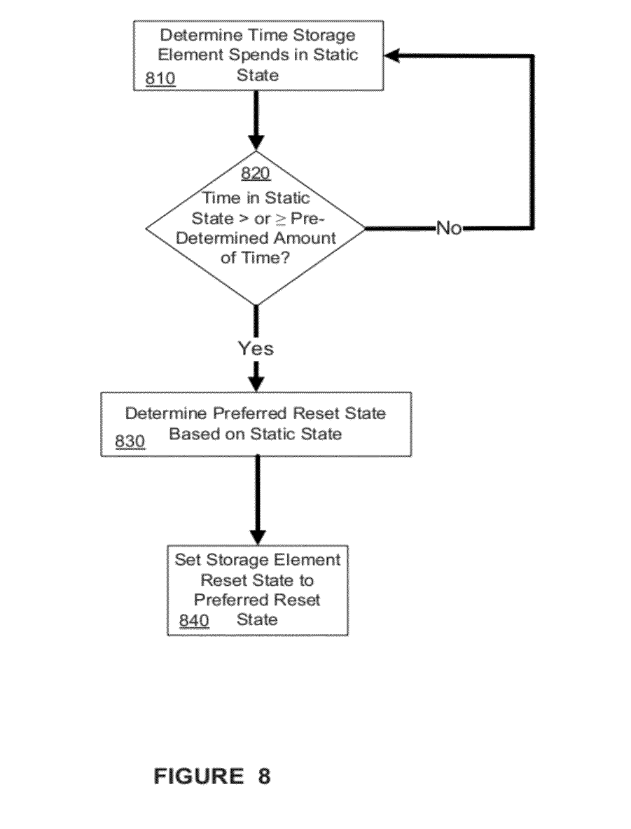

Turning now to FIG. 8, an operational flowchart for determining a preferred reset state according to one embodiment of the present invention, is depicted. At step 810, an amount of time a storage element 310 has spent in a static state may be determined. The storage element 310 may be in a static state (e.g., holding a value of ‘1’ or ‘0’) for some length of time, for example, when the storage element 310 comes out of reset. At step 820, it is determined if the amount of time spent in the static state is at least (or greater than in some embodiments) a predetermined amount of time. The predetermined amount of time may be set by a user, a designer, an automated design system, and/or the like. In some embodiments, the predetermined amount of time may later be changed. If it is determined that the storage element 310 has spent less time (or not more time than) the predetermined amount of time in the static state, the flow proceeds back to step 810. If it is determined that the storage element 310 has spent at least (or greater than) the predetermined amount of time in the static state, the flow proceeds to step 830.

At step 830, a preferred reset state for the storage element 310 may be determined. The preferred reset state may be based, in whole or part, upon the static state in which the storage element has spent the predetermined amount of time. It is contemplated that the preferred reset state may change over time during the use and/or life of the storage element 310. Once the preferred reset state is determined, the flow proceeds to step 840 where the preferred reset state of the storage element 310 may be set.

In one embodiment, it may be determined if a storage element spends at least a predetermined amount of time in a static state. A preferred reset state for the storage element may be determined based upon at least the static state in which the storage element spends at least the predetermined amount of time. In other words, if a storage element, such as a flip-flop, a latch, a bitcell and/or a register, remains in a static state of ‘0’ or ‘1’ for a certain time period, it may be determined that the preferred reset state of the storage element should be the same as the static state value in which the storage element remains for the time period. The preferred reset state may then be set based at least upon the static state in which the storage element spends at least the predetermined amount of time.

It is further contemplated that, in some embodiments, different kinds of hardware descriptive languages (HDL) may be used in the process of designing and manufacturing very large scale integration circuits (VLSI circuits) such as semiconductor products and devices and/or other types semiconductor devices. Some examples of HDL are VHDL and Verilog/Verilog-XL, but other HDL formats not listed may be used. In one embodiment, the HDL code (e.g., register transfer level (RTL) code/data) may be used to generate Graphic Database System (GDS) data, GDSII data and the like. GDSII data, for example, is a descriptive file format and may be used in different embodiments to represent a three-dimensional model of a semiconductor product or device. Such models may be used by semiconductor manufacturing facilities to create semiconductor products and/or devices. The GDSII data may be stored as a database or other program storage structure. This data may also be stored on a computer readable storage device (e.g., the data storage unit(s) 160, the RAM 155, compact discs, DVDs, solid state storage and the like). In one embodiment, the GDSII data (or other similar data) may be adapted to configure a manufacturing facility (e.g., through the use of mask works) to create devices capable of embodying various aspects of the instant invention. In other words, in various embodiments, this GDSII data (or other similar data) may be programmed into a computer 100, processor 125/140 or controller, which may then control, in whole or part, the operation of a semiconductor manufacturing facility (or fab) 390 to create semiconductor products and devices. For example, in one embodiment, silicon wafers 330 containing various configurations of asymmetrically sized and/or skewed storage elements 310 optimized for leakage reduction may be created using the GDSII data (or other similar data).

It should also be noted that while various embodiments may be described in terms of storage elements optimized for leakage reduction, it is contemplated that the embodiments described herein may have a wide range of applicability, not just for specific implementations described here, as would be apparent to one of skill in the art having the benefit of this disclosure.

The particular embodiments disclosed above are illustrative only, as the invention may be modified and practiced in different but equivalent manners apparent to those skilled in the art having the benefit of the teachings herein. Furthermore, no limitations are intended to the details of construction or design as shown herein, other than as described in the claims below. It is therefore evident that the particular embodiments disclosed above may be altered or modified and all such variations are considered within the scope and spirit of the claimed invention.

Accordingly, the protection sought herein is as set forth in the claims below.

What is claimed:

1. A method comprising:
selecting a storage element based at least upon the storage element comprising at least one storage element component sized to reduce static current leakage;
determining a preferred reset state for the storage element, wherein the preferred reset state is based at least upon the reduction of static current leakage; and
setting the storage element reset state to the preferred reset state.

2. The method of claim 1, wherein selecting a storage element further comprises selecting a storage element comprising a pair of cross-coupled inverters and selecting a storage element based at least upon the pair of cross-coupled inverters being sized to reduce static current leakage.

3. The method of claim 2, wherein selecting a storage element is further based upon the pair of cross-coupled inverters comprising a stack of storage element components sized to reduce static current leakage.

4. The method of claim 2, wherein selecting a storage element further comprises basing the selection at least upon at least one of the storage element component or the pair of cross-coupled inverters being sized asymmetrically.

5. The method of claim 1, further comprising bringing the storage element out of reset into the preferred reset state.

6. The method of claim 1, further comprising:
selecting a storage element based at least upon a second storage element component being sized to reduce static current leakage; and
selecting a storage element based upon the storage element being one of a flip-flop, a latch, a bitcell or a register.

7. The method of claim 6, wherein the storage element is selected to be part of a processing device.

8. The method of claim 1, further comprising at least one of additionally stacking at least one storage element component to reduce leakage, changing a type of at least one storage element component to reduce leakage, or lengthening a channel length of at least one storage element component, to reduce leakage.

9. A method comprising:
selecting a storage element based at least upon the storage element comprising at least one storage element component adapted to increase at least one of speed or performance of the storage element;
determining a preferred reset state for the storage element, wherein the preferred reset state is based at least upon an increase of at least one of speed or performance of the storage element; and
setting the storage element reset state to the preferred reset state.

10. The method of claim 9, wherein selecting a storage element further comprises selecting a storage element comprising a pair of cross-coupled inverters and selecting a storage element based at least upon the pair of cross-coupled inverters comprising at least one characteristic to increase at least one of speed or performance of the storage element.

11. The method of claim 10, wherein selecting a storage element is further based upon the pair of cross-coupled inverters comprising a stack of storage element components comprising at least one characteristic to increase at least one of speed or performance of the storage element.

12. The method of claim 10, wherein selecting a storage element further comprises basing the selection at least upon at least one of the storage element component or the pair of cross-coupled inverters being sized asymmetrically.

13. The method of claim 9, further comprising bringing the storage element out of reset into the preferred reset state.

14. The method of claim 9, further comprising:
selecting a storage element based at least upon a second storage element component being sized to increase at least one of speed or performance of the storage element; and
selecting a storage element based upon the storage element being one of a flip-flop, a latch, a bitcell or a register.

15. The method of claim 14, wherein the storage element is selected to be part of a processing device.

16. A method comprising:
determining a preferred reset state for a storage element, wherein the preferred reset state is based upon at least one of a reduction in leakage current, an increase in the storage element speed or an increase in the storage element performance; and
setting the storage element reset state to the preferred reset state.

17. The method of claim 16, wherein determining the preferred reset state is based at least upon a reduction in leakage current and based at least upon the storage element comprising a storage element component related to the reduction in leakage current.

18. The method of claim 16, wherein determining the preferred reset state is based at least upon an increase in the storage element speed and based at least upon the storage element comprising a storage element component related to the increase in the storage element speed.

19. The method of claim 16, wherein determining the preferred reset state is based upon an increase in the storage element performance and based at least upon the storage element comprising a storage element component related to the increase in the storage element performance.

20. The method of claim 16, further comprising bringing the storage element out of reset into the preferred reset state.

21. The method of claim 16, further comprising determining the preferred reset state for a storage element based at least upon a size of a storage element component.

22. The method of claim 21, further comprising selecting the storage element to be part of a processing device.

23. A method comprising:
determining if a storage element spends at least a predetermined amount of time in a static state;
determining a preferred reset state for the storage element, wherein the preferred reset state is based upon at least the static state in which the storage element spends at least the predetermined amount of time; and
setting a preferred reset state based at least upon the static state in which the storage element spends at least the predetermined amount of time.

24. The method of claim 23, further comprising:
determining whether the storage element spends at least the predetermined amount of time in a different static state; and
changing the preferred reset state based at least upon the different static state in which the storage element spends the at least a predetermined amount of time.

25. The method of claim 23, further comprising:
modifying the predetermined amount of time such that the predetermined amount of time becomes a dynamically adjustable amount of time; and
determining the preferred reset state for the storage element based upon at least the static state in which the storage element spends the dynamically adjustable amount of time.

26. The method of claim 23, further comprising bringing the storage element out of reset into the preferred reset state.

27. The method of claim 23, further comprising determining the preferred reset state based at least upon at least one power savings consideration.

28. The method of claim 23, further comprising selecting the storage element to be part of a processing device.
